(19) United States
(12) Patent Application Publication
(10) Pub. No.: US 2016/0259079 A1
(43) Pub. Date: Sep. 8, 2016

(54) Distributed Acoustic Sensing for Passive Ranging

(71) Applicant: HALLIBURTON ENERGY SERVICES INC., Houston, TX (US)

(72) Inventors: Glenn A. Wilson, Houston, TX (US); Burkay Donderici, Houston, TX (US)

(21) Appl. No.: 15/029,212

(22) PCT Filed: Dec. 17, 2013
(86) PCT No.: PCT/US13/75686

§ 371 Date: Apr. 13, 2016

(51) Int. Cl. G01V 1/42; E21B 47/12; E21B 47/024; E21B 47/09; E21B 7/04; E21B 7/06

(52) U.S. Cl. CPC G01V 1/42; E21B 7/04; E21B 7/06; E21B 47/024; E21B 47/09; E21B 47/123

(57) ABSTRACT

A passive system for ranging between two wellbores where a distributed acoustic sensor system is deployed in a first wellbore and a drill bit in a second wellbore being drilled is utilized and an acoustic source to generate an acoustic signal for measurement by the distributed acoustic sensor system. The dynamic strain along the distributed acoustic sensor system is detected with an optical interrogation system and utilized to determine direction and distance between the first wellbore and the second wellbore.

### FIELD OF THE INVENTION

The invention relates to borehole drilling operations, and more particularly to methods and systems for tracking the drilling of multiple boreholes relative to one another. Most particularly, the invention relates to methods and systems for passively determining the relative location of a target well from a borehole being drilled utilizing a distributed acoustic sensor positioned in the target well.

### BACKGROUND OF THE INVENTION

As easy-to-access and easy-to-produce hydrocarbon resources are depleted, there is an increased demand for more advanced recovery procedures. One such procedure is steam assisted gravity drainage (SAGD), a procedure that utilizes steam in conjunction with two spaced apart wellbores. Specifically, SAGD addresses the mobility problem of heavy oil in a formation through the injection of high pressure, high temperature steam into the formation. This high pressure, high temperature steam reduces the viscosity of the heavy oil in order to enhance extraction. The injection of steam into the formation occurs from a first wellbore (injector) that is drilled above and parallel to a second wellbore (producer). As the viscosity of the heavy oil in the formation around the first wellbore is reduced, the heavy oil drains into the lower second wellbore, from which the oil is extracted. In one or more embodiments, the two wellbores are drilled at a distance of only a few meters from one other. The placement of the injector wellbore needs to be achieved with very small margin in distance. If the injector wellbore is positioned too close to the producer wellbore, the producing well would be exposed to very high pressure and temperature. If the injector wellbore is positioned too far from the producer wellbore, the efficiency of the SAGD process is reduced. In order to assist in ensuring that the second wellbore is drilled and positioned as desired relative to the first wellbore, a survey of the two wellbores in the formation is often conducted. These surveying techniques are traditionally referred to as “ranging”.

Electromagnetic (EM) systems and methods have been employed in ranging to determine direction and distance between two wellbores. In EM ranging systems, an elongated conductive pipe string, such as the wellbore casing, is disposed in one of the wellbores. This wellbore is typically referred to as the “target” wellbore and usually represents the SAGD injector wellbore. In any event, a current is applied to the target wellbore conductive pipe string by a low-frequency current source. Currents flow along the wellbore casing and leak into the formation. The currents result in an EM field around the target wellbore. The EM fields from the currents on the target wellbore casing are measured using an electromagnetic field sensor system disposed in the other wellbore, which is typically the wellbore in the process of being drilled. This second wellbore usually represents the SAGD producer wellbore. The measured magnetic field can then be utilized to determine distance, direction and angle between two wellbores. Ranging systems in which a current is injected into the target wellbore in order to induce a magnetic field are referred to as “active” ranging systems.

It would be advantageous to provide a “passive” ranging system in which the need to inject current into the target wellbore is avoided.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. The drawing in which an element first appears is generally indicated by the left-most digit in the corresponding reference number.

FIG. 1 illustrates an embodiment of a passive ranging system in a SAGD drilling operation having an optical fiber disposed along a target wellbore and an acoustic source in a wellbore being drilled.

FIG. 2 illustrates an embodiment of a passive ranging system in a relief well operation having optical fiber disposed along a target wellbore and an acoustic source in a wellbore being drilled.

FIG. 3a illustrates an embodiment of a single optical waveguide utilized in a passive wellbore ranging system.

FIG. 3b illustrates an embodiment of multiple optical waveguides utilized in a passive wellbore ranging system.

FIG. 3c illustrates an embodiment of a single optical waveguide carried on a tool or pipe string and acoustically coupled to the formation.

FIG. 4 shows a flow chart of one method for passive ranging utilizing optical fiber disposed along a target wellbore and an acoustic source in a wellbore being drilled.

### DETAILED DESCRIPTION OF THE INVENTION

The foregoing disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper,” “uphole,” “downhole,” “upstream,” “downstream,” and the like, may be used herein for ease of description to describe one element or feature's relationship to another element(s) or feature(s) as illustrated in the FIGS. The spatially relative terms are intended to encompass different orientations of the apparatus in use or operation in addition to the orientation depicted in the FIGS. For example, if the apparatus in the FIGS. is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

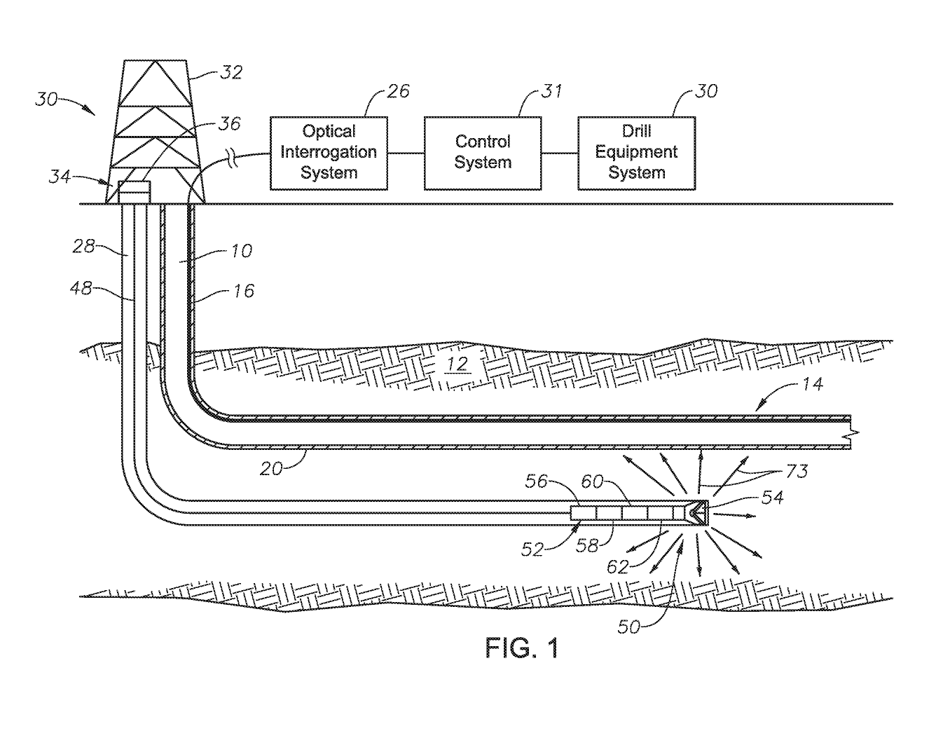

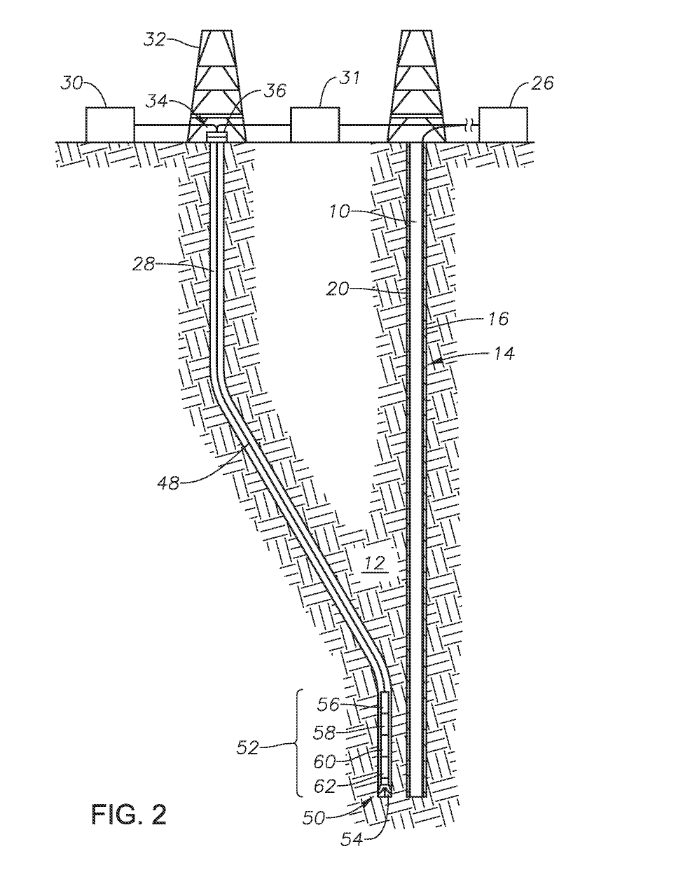

Referring initially to FIGS. 1 and 2, a first wellbore 10 extends through the various earth strata including formation 12. First wellbore 10 includes an acoustic ranging system 14 installed therein, which ranging system 14 includes at least one optical waveguide 16 disposed substantially along a portion of the length of wellbore 10. As will be described in more detail herein, the acoustic ranging system 14 employs optical waveguide 16 as a distributed acoustic sensor (DAS) to determine the directions and distances to subsurface infrastructures such as another wellbore. A DAS system will allow measuring in real-time of an acoustic signal arriving at the first wellbore. Such an acoustic signal will produce vibrations (e.g., pressure or strain fluctuations) in the optical waveguide. By detecting the vibrations produced by anomalies in the optical waveguide, the distance, direction and orientation of the optical waveguide at a specific point along the optical waveguide relative to an acoustic signal source can be determined. While the disclosure is not limited to a particular method for measuring the acoustic signal, in one or more embodiments, a method for measuring dynamic acoustic/vibration disturbances with a high frequency response (˜1 Hz to ≧10 kHz sampling frequency) in the optical waveguide is coherent Rayleigh backscatter detection. Likewise, in one or more embodiments, a method for measuring static strain/density disturbances in the optical waveguide is stimulated Brillouin backscatter detection.

In one or more embodiments, a plurality of optical waveguides may be disposed along wellbore 10. The plurality of optical waveguides may be spaced apart around wellbore 10 to form a two-dimensional array. In one or more embodiments, multiple optical waveguides can be placed at different azimuths about wellbore 10. As used herein, “optical waveguide” includes one or more optical waveguides (such as optical fiber(s), optical ribbon(s) and other types of optical waveguides), and further may include the any sheath or casing disposed around the optical waveguide. Moreover, the waveguide may be single mode or multi-mode.

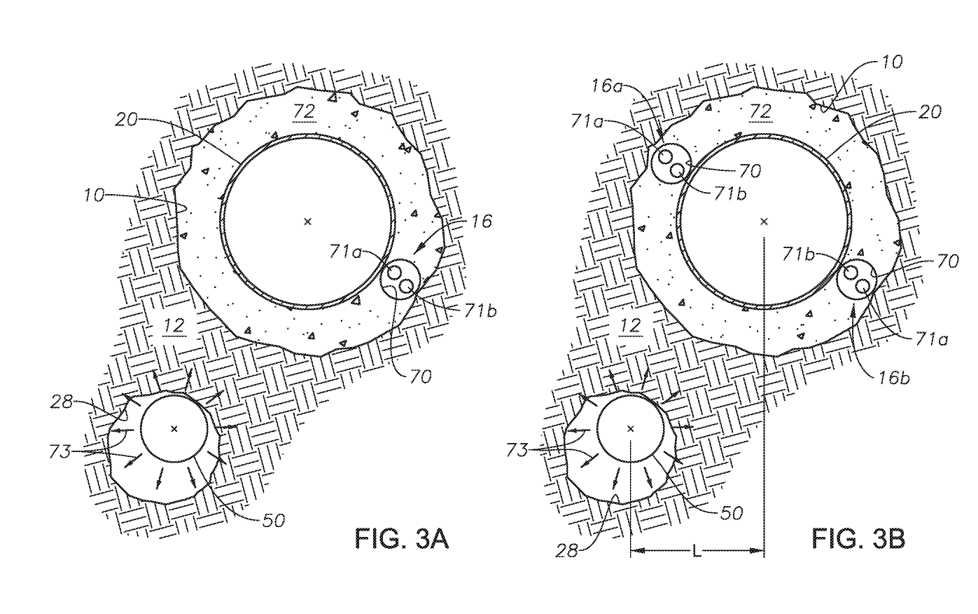

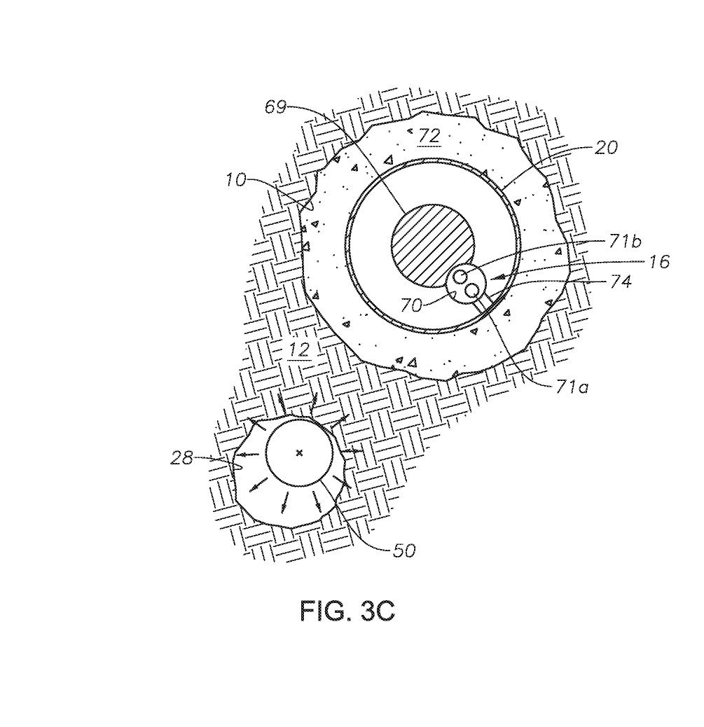

In one or more embodiments, optical waveguide 16 may be positioned so as to be in direct or indirect contact with formation 12. In this regard, wellbore 10 may be cased or uncased. To the extent wellbore 10 is cased, as indicated by casing 20, in one or more embodiments, the optical waveguide 16 is attached or otherwise carried on the exterior of the casing 20. Persons of skill in the art will appreciate that casing 20 may be cemented in place within wellbore 10, and in such case, the optical waveguide 16 may be deployed in the cement. For either cased or uncased wellbores, in one or more embodiments, the optical waveguide 16 may be deployed in indirect contact with formation 12 via an acoustic conducting member (such as shown in FIG. 3c) that provides acoustic coupling between the optical waveguide 16 and the formation 12. Moreover, the optical waveguide 16 may be temporarily or permanently installed within wellbore 10.

An optical interrogation system 26 is disposed in optical communication with optical waveguide 16. In certain embodiments, the interrogation system may drive an optical signal along the optical fiber. In certain embodiments, the optical signal may be a pulsed light, such as pulsed laser. In one or more embodiments, the fiber optic interrogation system 26 may be a Brillouin backscattering detector that detects and records backscattered light. Since vibrations along the optical fiber create small changes in the refractive index of the optical fiber, the time of a backscattered signal can be correlated to a specific position along the optical fiber. By pulsing the laser repeatedly, other information such as the phase and/or frequency of the signal can be obtained. The DAS system has maximum directional sensitivity in the lateral direction of the optical fiber, with minimal directional sensitivity in the axial direction of the optical fiber.

In one or more embodiments, the fiber optic interrogation system 26 may be a Raman backscattering detector. The disclosure is not limited to any particular type of fiber optic interrogation system, but may be selected based on the optical response for the particular survey system with which it is utilized. For example, the optical waveguide 16 may be positioned in wellbore 10 for purposes in addition to the optical ranging system described herein and the fiber optic interrogation system 26 may be selected accordingly. In this regard, in one or more embodiments, other types of fiber optic sensors may be disposed along an optical fiber, including but not limited to temperature, chemical and electromagnetic sensors.

With ongoing reference to FIGS. 1 and 2, there is shown a second wellbore 28. A drilling system 30 is generally shown associated therewith. Drilling system 30 may include a drilling platform 32 positioned over formation 12, and a wellhead installation 34, including blowout preventers 36. Platform 32 may be disposed for raising and lowering a conveyance mechanism 48.

Attached to the end of conveyance mechanism 48 is an acoustic or vibrational source 50. In one or more embodiments, acoustic source 50 may be part of the bottom-hole-assembly (BHA) 52 of a drilling system. In this regard, acoustic source 50 may be a drill bit or may be another vibrational or acoustic generator carried by BHA 52. To the extent the acoustic or vibrational source is a source other than the drill bit, in one or more embodiments, an acoustic signal may be generated at a frequency different than the general acoustic frequency generated by the drill bit. In one or more embodiments, the acoustic or vibrational source is indirect contact with the formation, such as at the face of a drill bit, to maximize the acoustic or vibrational signal propagated into the formation. For reasons that will be appreciated, in such case, the acoustic signal can be propagated or otherwise injected into the formation without suspending drilling operations. The second acoustic signal is selected so as not to be interfered with by the acoustic signal from the drill bit.

With respect to FIG. 1, to the extent drilling system 30 is being utilized to actively drill second wellbore 28, conveyance mechanism 48 may be a tubing string or drill string, having a BHA 52 attached to the end of string 48. BHA 52 includes a drill bit 54. BHA may also include a power system 56, such as a mud motor, a directional steering system 58, a control system 60, and other sensors and instrumentation 62. As will be appreciated by persons of skill in the art, the BHA 52 illustrated in FIG. 1 may be a measurement-while-drilling or logging-while-drilling system in which passive ranging can be utilized to guide drill bit 54 while a drill string is deployed in wellbore 28.

With respect to FIG. 2, conveyance system 48 may be a cable such as a wireline, slickline or the like and used to lower acoustic source 50 into wellbore 28. Power and communications to acoustic source 50, if any, may be carried locally by appropriate modules 56-62 or may be transmitted via conveyance system 48.

The acoustic ranging system 14 as described herein may be deployed on land or may be deployed offshore.

Moreover, the acoustic ranging system 14 is not limited to any particular orientation of the first and second wellbores. As depicted in FIG. 1, first and second wellbores 10, 28, respectively are substantially horizontal wellbores. In such case, fiber optic ranging system 14 may be particularly useful in ranging for SAGD operations. Alternatively, as depicted in FIG. 2, first and second wellbores 10, 28, respectively are substantially vertical wellbores. Thus, fiber optic ranging system 14 may be used in drilling relief wells or intersecting wells, such as when it is desirable to establish direct fluid communication between two wells. This may be particularly useful in well intervention operations, for example.

In any event, a control system 31 may also be deployed to control drilling system 30 based on measurements made with interrogation system 26.

As deployed, the fiber optic ranging system 14 is utilized for acoustic sensing and employs one or more optical waveguides to detect vibrations along the optical waveguide disposed along the wellbore 10. The waveguide functions as an extended continuous fiber optic microphone, hydrophone, or accelerometer, whereby the vibrational energy is transformed into a dynamic strain along the optical waveguide.

Such strains within the optical waveguide act to generate a proportional optical path length change measurable by various techniques. These techniques include, but are not limited to, interferometric (e.g., coherent phase Rayleigh), polarimetric, fiber Bragg grating wavelength shift, or photon-phonon-photon (Brillouin) frequency shift measurements for light waves propagating along the length of the optical waveguide.

Optical path length changes result in a similarly proportional optical phase change or Brillioun frequency/phase shift of the light wave at a particular distance-time, thus allowing remote surface detection and monitoring of vibration amplitude and location continuously along the optical fiber.

Coherent phase Rayleigh sensing may be utilized to perform Distributed Vibration Sensing (DVS) or Distributed Acoustic Sensing (DAS). Stimulated Brillouin sensing may be utilized to perform Distributed Strain Sensing (DSS) for sensing relatively static strain changes along an optical waveguide disposed linearly along the wellbore 10, but other techniques (such as coherent phase Rayleigh sensing) may be used if desired.

Although the optical waveguide is depicted in FIG. 1 as being installed by itself within the casing 20, this is but one embodiment of a wide variety of possible ways in which the optical waveguide 16 may be installed in the wellbore 10. The optical waveguide 16 could instead be positioned in a sidewall of the casing 20, inside of a tubing which is positioned inside or outside of the casing or a tubular string within the casing, in the cement, or otherwise positioned in the well.

FIG. 3a illustrates an axial view of a single optical waveguide 16 disposed proximate or adjacent a wellbore 10, and in particular, along the exterior of a casing member 20, such as the illustrated casing section. Optical waveguide 16 may include a protective casing 70 or otherwise form an optical fiber cable. In the illustrated embodiment, optical waveguide 16 includes two optical fibers 71a, 71b, although as explained above, acoustic ranging system 14 is not limited by the number of optical waveguides or number of optical fibers utilized therein. Optical waveguide 16 may be carried on or otherwise attached to casing member 20 or disposed in the cement 72 about the casing in order to provide acoustic coupling with the formation. Also generally depicted is the acoustic source 50 within second wellbore 28. Lines 73 represent an acoustic signal propagating out from acoustic source 50 into formation 12. In one or more embodiments, optical waveguide 16 may be deployed to extend along a substantially straight path along a portion of the length of the wellbore 10, while in other embodiments, optical waveguide 16 may be spirally wound about a portion of the length of the wellbore 10.

FIG. 3b illustrates an axial view of two optical waveguides 16 disposed proximate or adjacent a wellbore 10, and in particular, along the exterior of a casing member 20, such as the illustrated casing section. Optical waveguides 16 may include a protective casing 70 or otherwise form an optical fiber cable. In the illustrated embodiment, optical waveguides 16 each include two optical fibers 71a, 71b, although as explained above, acoustic ranging system 14 is not limited by the number of optical waveguides or number of optical fibers utilized therein. Optical waveguide 16 may be carried on or otherwise attached to casing member 20 or disposed in the cement 72 about the casing. Also generally depicted is the acoustic source 50 within second wellbore 28. Lines 73 represent an acoustic signal propagating out from acoustic source 50 into formation 12. In one or more embodiments, one optical waveguide 16 may be deployed to extend along a substantially straight path along a portion of the length of the wellbore 10, while a second optical waveguide 16 may be spirally wound about a portion of the length of the wellbore 10. In one or more embodiments, the two waveguides 16 may be deployed along the same portion of the length of the wellbore 10.

FIG. 3c illustrates an axial view of a single optical waveguide 16 disposed proximate or adjacent a wellbore 10, and in particular, along the interior of a casing member 20, such as the illustrated casing section. Optical waveguide 16 may include a protective casing 70 or otherwise form an optical fiber cable. In the illustrated embodiment, optical waveguide 16 includes two optical fibers 71a, 71b, although as explained above, acoustic ranging system 14 is not limited by the number of optical waveguides or number of optical fibers utilized therein. Optical waveguide 16 may be carried on or otherwise attached to the interior of casing member 20 or carried on another tubular member, tool string or the like 69 disposed within casing member 20. If disposed within casing member 20, or in the instance of an uncased wellbore, if disposed within wellbore 10, optical waveguide 16 may be in physical contact with casing member 20 or formation 12, as the case may be, via an arm, rib, protrusion, or similar physical body 74 that can readily transfer vibrations within formation 12 to the optical fiber 17 of optical waveguide 16, thereby providing acoustic coupling with the formation 12. Also generally depicted is the acoustic source 50 within second wellbore 28. Lines 73 represent an acoustic signal propagating out from acoustic source 50 into formation 12.

In one or more embodiments, the waveguides 16 may only utilize single mode waveguides for detecting Rayleigh and/or Brillouin backscatter. If Raman backscatter detection is utilized (e.g., for distributed temperature sensing), then multi-mode waveguide(s) may also be used for this purpose. However, it should be understood that multi-mode waveguides may be used for detecting Rayleigh and/or Brillouin backscatter, and/or single mode waveguides may be used for detecting Raman backscatter, if desired, but resolution may be detrimentally affected.

In one or more embodiments, the optical fibers 71a, 71b may be single mode optical fibers. The single mode optical fibers 71a, 71b bay be optically connected to each other at the bottom of the waveguide 16, for example, using a conventional looped fiber or mini-bend. These elements are well known to those skilled in the art, and so are not described further herein.

In one example, a Brillouin backscattering detector is connected to the single mode optical fibers 71a, 71b for detecting Brillouin backscattering due to light transmitted through the fibers. In another embodiment, one or more optical fibers 71a, 71b or waveguides may be multi-mode. A Raman backscattering detector is connected to the multi-mode optical waveguide for detecting Raman backscattering due to light transmitted through the optical waveguide.

However, it should be understood that any optical detectors and any combination of optical detecting equipment may be connected to the optical waveguides 14 in keeping with the principles of this disclosure. For example, a coherent phase Rayleigh backscattering detector, an interferometer, or any other types of optical instruments may be used.

In any event, with reference to all of the FIGS. 1-3, the location of the source 50 relative to wellbore 10 can be determined from seismic processing methods similar to those employed in DAS-based microseismic analysis (e.g., ray tracing through an a priori acoustic velocity model). In one or more embodiments, the ranging is derived from seismic processing techniques, such as ray tracing. In one or more embodiments, an ray tracing algorithm based on the laws governing reflection and fraction of elastic and/or inelastic seismic wave propagation can be used to determine the direction and distance of wavefields propagating through a velocity model from sources (i.e., events occurring at BHA) and the distributed acoustic sensors. This algorithm may be iterative.

In one or more embodiments, a migration algorithm based on the laws governing adjoint operators of elastic and/or inelastic seismic wave propagation can be used to determine the direction and distance of wavefields propagating from sources (i.e., events occurring at BHA) and the distributed acoustic sensors. This migration algorithm also may be iterative.

In other embodiments, an inversion algorithm based on the laws governing elastic and/or inelastic seismic wave propagation can be used to determine the direction and distance of wavefields propagating from sources (i.e., events occurring at BHA) and the distributed acoustic sensors. This inversion algorithm may be based on stochastic and/or deterministic methods of optimization.

In different embodiments of the processing algorithms used, a velocity model of the geological formations exists. This velocity model can be constructed a priori from seismic data (including but not limited to 2D/3D/4D seismic, VSP and/or seismic interferometry) and/or sonic data (including but not limited to LWD and/or wireline), and may be generated using computational algorithms for accurate model constructions, such as well tying and geostatistics. The velocity model may contain compressional and/or shear velocities, which may be anisotropic. In one or more embodiments of the processing algorithms used, a density model may also be used in acoustic impedance-based data processing algorithms.

In one or more embodiments, multiple optical fibers can be deployed at different azimuthal positions about the well casing for the purpose of calculating differential-(or gradient-) based acoustic measurements to enhance azimuth sensitivity with respect to the well casing. One such embodiment is illustrated in FIG. 3b, where two optical fibers are placed on azimuthally opposite positions of the wellbore 10 and can be used to determine the lateral offset “L” of the BHA from the wellbore 10. In such embodiments, the direction and distance between the BHA and the first well can be retrieved from differences in arrival times of the acoustic signal to the different optical waveguides positioned around the wellbore.

In one or more embodiments, a single optical fiber can be deployed about the well casing as a spiral at periodic or non-periodic intervals to enhance azimuth sensitivity with respect to the well casing. In such embodiments, the direction and distance between the BHA and the first well can be retrieved from variants of the above described processing methods.

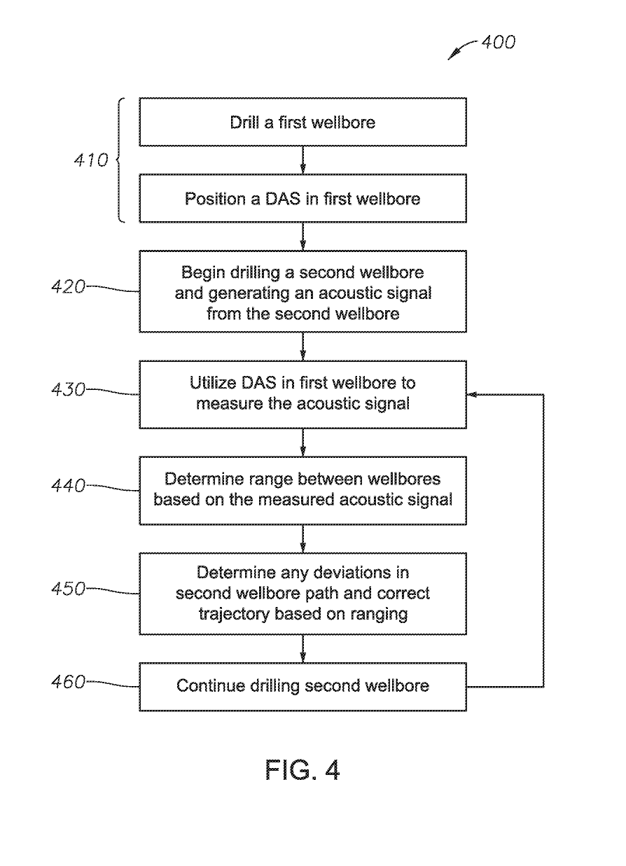

FIG. 4 is a flowchart illustrating embodiments of an acoustic ranging method 400 of the disclosure. Without limiting the scope of the disclosure, in one or more embodiments, the acoustic ranging method 400 may be utilized in SAGD operations or for drilling intersecting wellbores, such as in well intervention operations. In any event, in a first step 410, a DAS system is deployed in a first wellbore so that an acoustic waveguide is acoustically coupled with the formation in which the first wellbore is drilled. The DAS system may be as described above with respect to the acoustic ranging system 14. Thus, a first wellbore is drilled and casing is cemented in place within the first wellbore. An optical waveguide is disposed in the cement about the casing. To the extent two optical waveguides are utilized, the optical waveguides may be placed on opposite sides of the casing, in one or more embodiments, approximately 180 degrees apart. Alternatively, one optical waveguide may be deployed to extend along a substantially straight path along a portion of the length of the first wellbore, while a second optical waveguide may be spirally wound about a portion of the length of the first wellbore. In one or more embodiments, the two waveguides may be deployed along the same portion of the length of the first wellbore. In some embodiments, the method may be performed in uncased wellbores, in which case, the DAS may be positioned without deployment of casing and cementing.

In step 420, drilling of a second wellbore is commenced. Meanwhile, an acoustic signal is propagated into the formation about the first wellbore from the second wellbore. In one or more embodiments, the acoustic signal is generated from the drilling itself, and in particular, the engagement of the drill bit with the formation. In other embodiments, the acoustic signal may be generated from another source in the second wellbore, such as an acoustic single generator proximate or adjacent the drill bit. In this regard, the acoustic signal of the source may be selected to be different that the acoustic signal generated from drilling.

In step 430, the acoustic signal generated from the second wellbore is measured in the first wellbore utilizing the DAS system. For example, a light source drives a light along the optical waveguide in the first wellbore. The return light, or portion thereof, is detected and utilized to determine the acoustic signal interacting with the first wellbore at a particular location along the first wellbore. In one or more embodiments, the acoustic signal may be measured utilizing Brillouin backscattering to detect and record backscattered light. In one or more embodiments, the acoustic signal may be measured utilizing Raman backscattering to detect and record backscattered light.

In step 440, the range, and in particular, the direction and distance, between the acoustic source and the first wellbore is derived utilizing the measured acoustic signal. In one or more embodiments, the ranging is derived from seismic processing techniques, such as ray tracing. In one or more embodiments, an ray tracing algorithm based on the laws governing reflection and fraction of elastic and/or inelastic seismic wave propagation can be used to determine the direction and distance of wavefields propagating through a velocity model from sources (i.e., events occurring at BHA) and the distributed acoustic sensors. This algorithm may be iterative.

In one or more embodiments, a migration algorithm based on the laws governing adjoint operators of elastic and/or inelastic seismic wave propagation can be used to determine the direction and distance of wavefields propagating from sources (i.e., events occurring at BHA) and the distributed acoustic sensors. This migration algorithm also may be iterative.

In other embodiments, an inversion algorithm based on the laws governing elastic and/or inelastic seismic wave propagation can be used to determine the direction and distance of wavefields propagating from sources (i.e., events occurring at the BHA) and the distributed acoustic sensors. This inversion algorithm may be based on stochastic and/or deterministic methods of optimization.

In different embodiments of the processing algorithms used, a velocity model of the geological formations exists. This velocity model can be constructed a priori from seismic data (including but not limited to 2D/3D/4D seismic, VSP and/or seismic interferometry) and/or sonic data (including but not limited to LWD and/or wireline), and may be generated using computational algorithms for accurate model constructions, such as well tying and geostatistics. The velocity model may contain compressional and/or shear velocities, which may be anisotropic. In one or more embodiments of the processing algorithms used, a density model may also be used in acoustic impedance-based data processing algorithms.

To the extent two or more optical waveguides are deployed along the same length of a wellbore, differences in the acoustic signals between the two waveguides can be processed to determine a direction. For example, the differences between an acoustic signal in a first optical waveguide deployed to extend along a substantially straight path along a portion of the length of a wellbore and a second optical waveguide spirally wound about a portion of the length of the wellbore.

In step 450, the direction and distance can be utilized to determine if any deviations in the desired trajectory of the second wellbore exist. In this regard, drilling of the second wellbore is initiated in accordance with a predetermined drilling plan so that the second wellbore is drilled at a desired trajectory relative to the first wellbore. For example, the second wellbore may be drilled so that a portion of the second wellbore is parallel with a portion of the first wellbore and spaced apart therefrom a distance of approximately 5-10 meters, such as when performing SAGD operations. If deviations between the actual trajectory and desired trajectory of second wellbore are identified, then the trajectory of the second wellbore is adjusted. In this regard, the directional drilling tool may be utilized to reposition the drill bit so as to correct the trajectory of the second wellbore.

Once the trajectory of the second wellbore has been corrected, in step 460, drilling of the second wellbore is continued. It will be appreciated that the corrections to the second wellbore trajectory can be made on the fly or during suspension of drilling.

Moreover, the acoustic ranging system as described may be utilized as a closed-loop system. Thus, as shown in FIG. 4, as drilling is continued in step 460, acoustic ranging and correction can be repeated to ensure the on-going accuracy of the second wellbore trajectory.

In one or more embodiments, the DAS system in first wellbore can be utilized, either during drilling of the second wellbore or afterwards, during production operations, with other fiber optic sensors, including but not limited to fiber-optic-based temperature, chemical, and/or electromagnetic sensor systems to make corresponding measurements associated therewith.

It will be appreciated that since the fiber optic ranging system 14 as described herein is a passive system and does not require transmission of a current along the target wellbore, casing member 20 need not be conductive. Thus, casing member 20 may include one or more non-conductive joints as desired.

In all embodiments of the system, the DAS system response (e.g., transfer functions) can be characterized using at least one known seismic/acoustic/sonic source deployed from the surface, from within the known wellbore, or from within a different wellbore. This characterization can, for example, determine the positions/orientation of the optical fiber along the target wellbore.

The acoustic ranging system as described herein is desirable because it is a passive system, such that the distance, direction, and angle of the BHA with respect to the target wellbore can be determined from acoustic signals generating by the BHA during drilling, as measured by a DAS system. As a passive ranging technique, the BHA does not require any active acoustic and/or electromagnetic LWD sources and/or sensors, nor does the target wellbore require an electrically conductive body or current source for ranging activities. Moreover, the DAS system can be deployed with other fiber optic systems, such as distributed temperature sensing (DTS) systems as are relevant in SAGD production applications. Additionally, the acoustic ranging system and methods can be operated in real-time. Upon completion of the second wellbore, the DAS system can continue to be operated after drilling for other acoustic monitoring applications in SAGD production applications (e.g., microseismic monitoring, multi-phase flow monitoring, etc.).

Thus, a wellbore ranging system has been described. Embodiments of the wellbore ranging system may generally include an optical waveguide disposed in a first wellbore of a formation; and an acoustic source disposed in a second wellbore and acoustically coupled with the formation. In other embodiments, an acoustic ranging system for wellbores has been described and generally includes a first wellbore with a fiber optic ranging system disposed therein; and an acoustic source disposed to generate an acoustic signal. For any of the foregoing embodiments, the system may include any one of the following elements, alone or in combination with each other:
The optical waveguide is an optical fiber cable.
The optical waveguide is disposed along an axial length of the first wellbore.
A second optical fiber cable along the same axial length of the first wellbore along which a first optical fiber cable is positioned.
An optical waveguide spirals around the first wellbore along an axial length of the first wellbore.
The first wellbore has a first axial length and the second wellbore has a second axial length and a distal end, wherein the acoustic source in the second wellbore is adjacent the distal end.
An optical fiber cable is a distributed acoustic sensor.
The distributed optical sensor is a distributed vibrational sensor.
An optical waveguide disposed along a portion of the length of the first wellbore.
An optical waveguide interrogation system in optical communication with the optical waveguide.
An optical interrogation system that comprises a Rayleigh backscatter optical detector.
An optical interrogation system that comprises a Brillouin backscatter optical detector.
A plurality of optical waveguides extending along at least a portion of the length of the first wellbore.
A plurality of optical waveguides spaced apart around a perimeter of the first wellbore.
Two optical waveguides spaced 180 degrees apart about the perimeter of the first wellbore.
The optical waveguide is a single mode optical waveguide.
The optical waveguide is a multi-mode optical waveguide.
The optical waveguide is an optical fiber.
The optical waveguide is an optical ribbon.
At least a portion of the optical waveguide is spirally disposed about a length of the first wellbore.
A casing disposed in the first wellbore, the casing having an exterior surface, wherein the optical waveguide is disposed proximate or adjacent the exterior surface of the casing.
The optical waveguide is cemented in place proximate or adjacent the casing.
The optical waveguide is disposed within the wellbore so as to form an acoustic transmission path between the optical waveguide and the formation.
The optical waveguide is permanently installed in the first wellbore.
The optical waveguide is temporarily installed in the first wellbore.
The optical waveguide is carried on a pipe string disposed within the first wellbore.
The optical waveguide is carried on a tubing string disposed within the first wellbore.
An acoustic conducting member disposed within the first wellbore between the optical waveguide and the formation.
An optical waveguide interrogation system in optical communication with the optical waveguide, a control system in communication with the optical waveguide interrogation system and a drilling system in communication with the control system, the drilling further comprising a drill bit disposed in the second wellbore.
The first wellbore comprises a non-conductive casing along at least a portion of its length.
The acoustic source is a drill bit.
A drill bit is deployed at the end of a drill string as part of bottom hole assembly.
A bottom hole assembly comprises the acoustic source.
A bottom hole assembly comprises a directional steering system and a power system.
The acoustic source is deployed at the end of a cable.
The optical waveguide disposed in a portion of the first wellbore that is substantially horizontal and the acoustic source is disposed in a portion of the second wellbore that is substantially horizontal.
The optical waveguide disposed in a portion of the first wellbore that is substantially vertical and the acoustic source is disposed in a portion of the second wellbore that is substantially vertical.

A wellbore ranging method has been described. Embodiments of the wellbore ranging method may include deploying a distributed acoustic sensing system in a first wellbore; utilizing an acoustic source outside of the first wellbore to generate an acoustic signal; detecting the acoustic signal with the distributed acoustic sensing system; and determining the position of the first wellbore in a formation based on the detected acoustic signal. For the foregoing embodiments, the method may include any one of the following steps, alone or in combination with each other:
Deploying the acoustic source in a second wellbore within the formation.
Positioning an optical waveguide along at least a portion of the length of the first wellbore.
Acoustically coupling a deployed optical waveguide with the formation.
Cementing an optical waveguide in place in the first wellbore.
Determining a direction of the first wellbore.
Positioning an optical waveguide proximate or adjacent the exterior of tubular casing disposed in the first wellbore.
Positioning a second optical waveguide along at least a portion of the length of the first wellbore so as to be spaced apart from the first optical waveguide.
Detecting vibrations along an optical waveguide.
Transforming vibrations from an acoustic source into dynamic strain along an optical waveguide.
Drilling a second wellbore and carrying an acoustic source on the drill string utilized to drill the second wellbore.
Utilizing a drill bit deployed by the drill string to generate the acoustic signal.
Propagating an optical signal along an optical waveguide and measuring the returning signal.
Utilizing a light source to drive light along an optical waveguide.
Forming an acoustic transmission path between an optical waveguide and the formation.
Measuring Brillouin backscattering.
Measuring Raman backscattering.
Measuring Rayleigh backscattering.
Utilizing ray tracing to determine the position of the first wellbore.
Utilizing a measured magnetic field and a detected acoustic signal to determine range between a first and second wellbore.
Utilizing a detected acoustic signal in the first wellbore to determine distribution of electric current along a conductive member in the first wellbore.
Utilizing a detected acoustic signal in the first wellbore to determine the magnitude of electric current at a particular point along a conductive member in the first wellbore.
Determining a direction and distance between the first wellbore and a second wellbore in which the acoustic source is deployed.
Determining a desired trajectory for a second wellbore relative to a first wellbore based on a drilling plan and, based on the determined position of the first wellbore, adjusting the actual trajectory of the second wellbore.
The desired trajectory of the second wellbore relative to the first wellbore is to be substantially parallel for at least a portion of the lengths of the two wellbores.
The substantially parallel portions of the two wellbores are substantially horizontal.
The desired trajectory of the second wellbore relative to the first wellbore is to intersect the second wellbore with the first wellbore.
Adjusting the trajectory of the second wellbore based on the difference between the desired trajectory and the actual trajectory.
Repositioning a drill bit in the second wellbore to adjust the trajectory of the second wellbore.
Drilling of the second wellbore is commenced prior to the step of determining the position of the second wellbore and drilling is continued following repositioning of the drill bit.
Repeated multiple times during the drilling of the second wellbore the steps of utilizing, detecting and determining.
Repeated continuously during the drilling of the second wellbore the steps of utilizing, detecting and determining.
Measuring a characteristic of the first wellbore utilizing the distributed sensing system, wherein the characteristic is selected from the group consisting of temperature, pressure, and vibration.
Spirally wrapping an optical waveguide along a portion of the casing of the first wellbore.
Determining a direction of a first wellbore based on a comparison between a first optical waveguide disposed along a portion of the length of the first wellbore and a second optical waveguide disposed along at least the same portion of the length of the first wellbore.
A step of comparing to determine a direction to the first wellbore comprises processing differences in the acoustic signal at the portion of the length along which two optical waveguides are disposed.
Utilizing the method in SAGD operations.
Utilizing the method in wellbore intersection operations.

While the foregoing disclosure is directed to the specific embodiments of the disclosure, various modifications will be apparent to those skilled in the art. It is intended that all variations within the scope and spirit of the appended claims be embraced by the foregoing disclosure.

1. A wellbore ranging system comprising:
an optical waveguide disposed in a first wellbore of a formation; and
an acoustic source disposed in a second wellbore and acoustically coupled with the formation.

2. The system of claim 1, wherein the optical waveguide is disposed along an axial length of the first wellbore.

3. The system of claim 1, wherein the optical waveguide is an optical fiber cable disposed along a portion of the axial length of the first wellbore.

4. The system of claim 3 further comprising a second optical fiber cable disposed along at least the same axial length of the first wellbore as the first optical fiber cable.

5. The system of claim 3, wherein the optical fiber cable is a distributed acoustic sensor.

6. The system of claim 1, wherein the optical waveguide spirals around the first wellbore.

7. The system of claim 1, wherein the first wellbore has a first axial length and the second wellbore has a second axial length and a distal end, wherein the acoustic source in the second wellbore is proximate the distal end.

8. The system of claim 1, further comprising a plurality of optical waveguides extending along at least a portion of an axial length of the first wellbore.

9. The system of claim 1, wherein the first wellbore further comprises a casing disposed therein, the casing having an exterior surface, wherein the optical waveguide is disposed adjacent the exterior surface of the casing so as to form an acoustic transmission path between the optical waveguide and the formation.

10. The system of claim 1, wherein the acoustic source is a drill bit deployed at the end of a drill string as part of bottom hole assembly, wherein the bottom hole assembly further comprises a directional steering system and a power system.

11. The system of claim 1, further comprising an optical waveguide interrogation system in optical communication with the optical waveguide.

12. The system of claim 11, further comprising a control system in communication with the optical waveguide interrogation system and a drilling system in communication with the control system, the drilling system further comprising a drill bit disposed in the second wellbore.

13. An acoustic ranging system for wellbores, the system comprising:
a first wellbore with a fiber optic ranging system disposed therein; and
an acoustic source disposed to generate an acoustic signal.

14. The system of claim 13, wherein the fiber optic ranging system comprises an optical waveguide disposed along a portion of the length of the first wellbore.

15. The system of claim 14, further comprising:
a second wellbore in the formation;
a control system in communication with an optical waveguide interrogation system; and
a drilling system in communication with the control system, the control system disposed to control the drilling system based on measurements from the optical waveguide interrogation system,
wherein:
the first wellbore further comprises a casing disposed therein,
the fiber optic ranging system comprises:
a distributed acoustic sensor disposed along an axial length of the first wellbore adjacent an exterior surface of the casing, and
the optical waveguide interrogation system in optical communication with the distributed acoustic sensor,
the acoustic source is a drill bit deployed on a drill string disposed in the second wellbore, and
the drill string comprises a bottom hole assembly, the bottom hole assembly comprising:
a directional steering system; and
a power system.

16. A wellbore ranging method comprising:
deploying a distributed acoustic sensing system in a first wellbore;
utilizing an acoustic source outside of the first wellbore to generate an acoustic signal;
detecting the acoustic signal with the distributed acoustic sensing system; and
determining the position of the first wellbore in a formation based on the detected acoustic signal.

17. The method of claim 16, further comprising deploying the acoustic source in a second wellbore within the formation.

18. The method of claim 16, further comprising determining a direction to the first wellbore.

19. The method of claim 16, wherein deploying comprises positioning an optical waveguide along at least a portion of the length of the first wellbore to acoustically couple the deployed optical waveguide with the formation.

20. The method of claim 19, further comprising determining a direction to the first wellbore by comparing at least two optical waveguides positioned along the same portion of the length of the first wellbore.

21. The method of claim 20, wherein one of the optical waveguides is a spiraling optical waveguide disposed along a portion of the length of the first wellbore; and wherein comparing comprises processing differences in the acoustic signal at the portion of the length along which both optical waveguides are disposed.

22. The method of claim 16, wherein detecting comprises utilizing a light source to drive light along the optical waveguide to detect vibrations along the waveguide based on dynamic strain along the optical waveguide.

23. The method of claim 16, further comprising:
drilling a second wellbore using a drill bit deployed by a drill string; and
generating the acoustic signal utilizing the drill bit.

24. The method of claim 23, wherein determining the position of the first wellbore comprises determining a direction and distance between the first wellbore and a second wellbore in which the acoustic source is deployed, and further comprising determining a desired trajectory for a second wellbore relative to a first wellbore based on a drilling plan and, based on the determined position of the first wellbore, adjusting the actual trajectory of the second wellbore.

25. The method of claim 24, further comprising:
adjusting the trajectory of the second wellbore based on the difference between the desired trajectory and the actual trajectory; and
repositioning a drill bit in the second wellbore to adjust the trajectory of the second wellbore,
wherein drilling of the second wellbore is commenced prior to the step of determining the position of the second wellbore and drilling is continued following repositioning of the drill bit.

26. The method of claim 23, wherein utilizing, detecting and determining are repeated multiple times during the drilling of the second wellbore.

27. The method of claim 16, further comprising measuring a characteristic of the first wellbore utilizing the distributed sensing system, wherein the characteristic is selected from the group consisting of temperature, pressure, and vibration.

28. The method of claim 16, further comprising performing a SAGD operation.
